(19) United States
(12) Patent Application Publication
(10) Pub. No.: US 2026/0365557 A1
(43) Pub. Date: Nov. 19, 2026

(54) GLASS MANUFACTURING APPARATUS

(71) Applicant: CORNING INCORPORATED, CORNING, NY (US)

(72) Inventors: Po-Lun Lo, Taichung City (TW); Kuan-Chang Pan, Taichung (TW); Chien-Chuan Wang, Taichung City (TW); Naiyue Zhou, Leland, NC (US)

(21) Appl. No.: 19/121,151

(22) PCT Filed: Nov. 9, 2023
(86) PCT No.: PCT/US2023/037048

§ 371 Date: Apr. 15, 2025

Related U.S. Application Data
(60) Provisional application No. 63/428,182, filed on Nov. 28, 2022.

(51) Int. Cl. C03B 33/02; C03B 17/06

(52) U.S. Cl. CPC C03B 33/0215; C03B 17/064

(57) ABSTRACT

A separation apparatus for a glass manufacturing apparatus includes a frame assembly having an upper frame portion and a lower frame portion, a carriage assembly, and a drive assembly including a screw shaft coupled to the carriage assembly. The glass manufacturing apparatus further includes a bellows extending over the screw shaft between the lower frame portion and the carriage assembly and a bellows cover extending over the bellows.

### CROSS-REFERENCE TO RELATED APPLICATIONS

This application claims the benefit of priority under 35 U.S.C. § 119 of U.S. Provisional Application Ser. No. 63/428182 filed on Nov. 28, 2022, the content of which is relied upon and incorporated herein by reference in its entirety.

### FIELD

The present disclosure relates to a glass manufacturing apparatus for forming a glass ribbon. More particularly, the glass manufacturing apparatus comprises a glass separation apparatus for separating glass sheets from the glass ribbon, the glass separation apparatus including a screw shaft, a protective bellows disposed around the screw shaft, and a bellows cover disposed around the protective bellows.

### BACKGROUND

It is known to manufacturing glass ribbon, for example by a down draw process, such as a fusion downdraw process. Typically, the glass ribbon is drawn continuously from a forming body. Glass sheets may be separated from the continuously moving glass ribbon by a glass separation apparatus. The glass separation apparatus may include a reciprocating carriage assembly that periodically moves downward with the glass ribbon, and which includes a scoring device that traverses along the carriage assembly and scores the glass ribbon during the downward traverse. Upon completion of the score, the carriage assembly is moved upward to await commencement of another cycle.

### SUMMARY

The separation apparatus includes a screw shaft and a nut assembly, the screw shaft coupled to a motor configured to rotate the screw shaft. The nut is coupled to the carriage assembly and is engaged with the screw shaft. Rotation of the screw shaft causes the nut assembly, and therefore the carriage assembly, to traverse along the rotating screw shaft, thereby providing the downward and upward reciprocating motion of the carriage assembly. To minimize friction, the screw shaft and/or nut assembly may be lubricated with a lubricant, for example oil or grease. The lubricant may comprise one or more petroleum products. Additionally, the scoring and separation process of the glass ribbon may generate glass debris (e.g., glass chips) that may interfere with proper operation of the screw shaft and nut assembly. Accordingly, a bellows may be positioned around the screw shaft such that the screw shaft is protected within a passage of the bellows. In embodiments, the bellows may not be a unitary structure, but instead may be formed from multiple cut pieces that are assembled, e.g., joined, to form the bellows.

The region of the separation apparatus may be heated to control cooling of the glass ribbon and reduce stress in the glass ribbon. This heating may cause the lubricant to vaporize and subsequently leak through seams of the bellows where individual pieces comprising the bellows are joined. The vaporized lubricant can condense on and stain the glass ribbon, thereby making the glass ribbon, and glass sheets separated therefrom, unsuitable for use. To provide further protection to the screw shaft and bellows, and to reduce vaporization of the lubricant, a bellows cover may be disposed about the bellows. The bellows cover may decrease a temperature of the environment around the bellows, e.g., inside and/or outside the bellows, thereby reducing vaporization of the lubricant.

Thus, in a first aspect, a glass manufacturing apparatus is disclosed comprising a forming body configured to form a glass ribbon, and a separation apparatus configured to separate the glass ribbon. The separation apparatus may comprise a frame assembly comprising an upper frame portion and a lower frame portion, a carriage assembly comprising a scoring device configured to score the glass ribbon, a drive assembly comprising a screw shaft extending between the upper frame portion and the lower frame portion, the screw shaft coupled to a drive motor configured to turn the screw shaft, and a nut assembly coupled to the carriage assembly and engaged with the screw shaft such that rotation of the screw shaft by the drive motor moves the carriage assembly along the screw shaft between the upper frame portion and the lower frame portion, a bellows extending over the screw shaft between the lower frame portion and the carriage assembly, and a bellows cover extending over the bellows, e.g., between the lower frame portion and the carriage assembly.

In a second aspect, the bellows of the first aspect may comprise aluminum.

In a third aspect, the bellows of any one of the first aspect or second aspect may comprise a polymer.

In a fourth aspect, the bellows cover of any one of the first aspect through the third aspect may comprise a fabric, for example a woven fabric, a knitted fabric, or a felted fabric.

In a fifth aspect, the fabric of the fourth aspect may comprise glass fiber, e.g., a fiberglass fabric.

In a sixth aspect, the glass manufacturing apparatus of any one of the first aspect through the fifth aspect may comprise a first clamp assembly coupling a first end of the bellows cover to the carriage assembly, the first clamp assembly comprising a first vacuum line extending between a vacuum source and the first clamp assembly such that the vacuum source is in fluid communication with a space between the bellows and the bellows cover.

In a seventh aspect, the glass manufacturing apparatus of the sixth aspect may further comprise a second clamp assembly coupling a second end of the bellows cover to the lower frame portion, the second clamp assembly comprising a second vacuum line extending between the vacuum source and the second clamp assembly such that the vacuum source is in fluid communication with the space between the bellows and the bellows cover.

In an eighth aspect, the glass manufacturing apparatus of any one of the first aspect through the fifth aspect may comprise a vacuum ring comprising a first ring wall, a second ring wall inside of and spaced apart from the first ring wall by a first gap and spaced apart from the screw shaft by a second gap, the bellows cover coupled to the first ring wall and the bellows coupled to the second ring wall, a first vacuum line coupled to the vacuum ring and in fluid communication with first gap and a second vacuum line coupled to the vacuum ring and in fluid communication with the second gap, and wherein the first gap is not in fluid communication with the second gap.

In a ninth aspect, the vacuum ring of the eighth aspect is a first vacuum ring, the first vacuum ring coupling a first end of the bellows cover to the lower frame portion.

In a tenth aspect, the drive assembly of any one of the first aspect through the ninth aspect may comprise a ball screw.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

FIG. 1 is a schematic view of an exemplary glass manufacturing apparatus;

FIG. 2 is an elevational view of an exemplary glass separation apparatus including drive assemblies having screw shafts, protective bellows, and bellows covers;

FIG. 3 is an elevational side view of a clamping apparatus used to secure a bellows cover around a screw shaft and associated bellows;

FIG. 4 is a cross-sectional view of a portion of a bellows cover showing a shaped wire attached to an end of the bellows cover;

FIG. 5 is a perspective view of an exemplary restraining clamp configured to retain a bellows cover to a clamping apparatus;

FIG. 6 is a cross-sectional top view of a vacuum ring in a plane orthogonal to a screw shaft for coupling a bellows and associated bellows cover around a screw shaft; and

FIG. 7 is a cross-sectional side view of the vacuum ring of FIG. 6.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure can be embodied in many different forms and should not be construed as limited to the embodiments set forth herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Ranges can be expressed herein as from “about” one particular value, and/or to “about” another particular value. When such a range is expressed, another embodiment includes from the one particular value to the other particular value. Similarly, when values are expressed as approximations by use of the antecedent “about,” it will be understood that the particular value forms another embodiment. It will be further understood that the endpoints of each of the ranges are significant both in relation to the other endpoint, and independently of the other endpoint.

Directional terms as used herein-for example, up, down, right, left, front, back, top, bottom—are made only with reference to the figures as drawn and are not intended to imply absolute orientation.

Unless otherwise expressly stated, it is in no way intended that a specific order or orientation of components of an apparatus be inferred in any respect. This holds for any possible non-express basis for interpretation, including matters of logic with respect to order of components, or orientation of components; plain meaning derived from grammatical organization or punctuation, and; the number or type of embodiments described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including,” and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

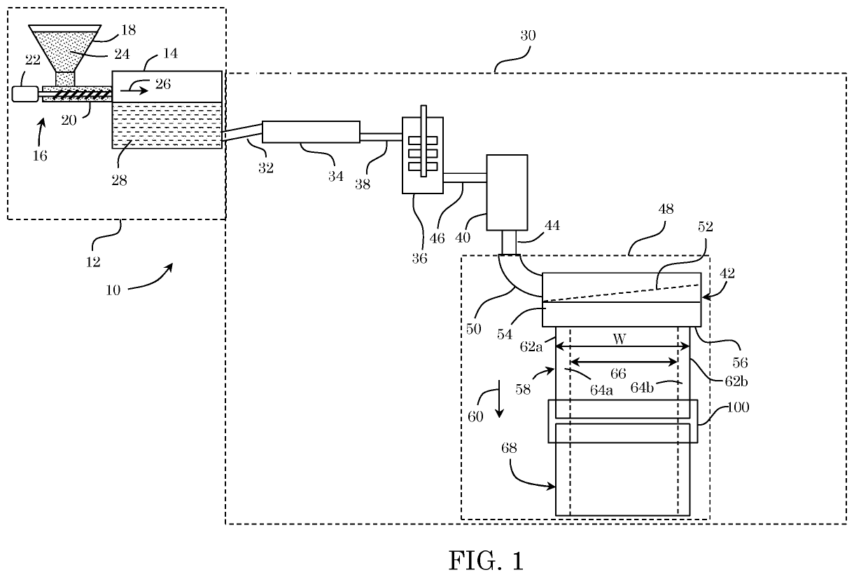

Shown in FIG. 1 is an exemplary glass manufacturing apparatus 10. In some embodiments, the glass manufacturing apparatus 10 can comprise a glass melting furnace 12 including a melting vessel 14. In addition to melting vessel 14, glass melting furnace 12 can optionally include one or more additional components such as heating elements (e.g., combustion burners and/or electrodes) configured to heat raw material and convert the raw material into molten glass. For example, melting vessel 14 may be an electrically boosted melting vessel, wherein energy is added to the raw material through both combustion burners and by direct heating, wherein an electrical current is passed through the raw material, the electrical current thereby adding energy via Joule heating of the raw material.

In further embodiments, glass melting furnace 12 can include other thermal management devices (e.g., insulation components) that reduce heat loss from the melting vessel. In still further embodiments, glass melting furnace 12 can include electronic and/or electromechanical devices that facilitate melting of the raw material into a glass melt. Glass melting furnace 12 can include support structures (e.g., support chassis, support member, etc.) or other components.

Melting vessel 14 can be formed from a refractory material, such as a refractory ceramic material, for example a refractory ceramic material comprising alumina or zirconia, although the refractory ceramic material can comprise other refractory materials, such as yttrium (e.g., yttria, yttria-stabilized zirconia, yttrium phosphate), zircon (ZrSiO₄) or alumina-zirconia-silica or even chrome oxide, used either alternatively or in any combination. In some examples, melting vessel 14 may be constructed from refractory ceramic bricks.

In some embodiments, glass melting furnace 12 can be incorporated as a component of a glass manufacturing apparatus configured to fabricate a glass article, for example a glass ribbon, although in further embodiments, the glass manufacturing apparatus can be configured to form other glass articles without limitation, such as glass rods, glass tubes, glass envelopes (for example, glass envelopes for lighting devices, e.g., light bulbs) and glass lenses, although many other glass articles are contemplated. In some examples, the melting furnace may be included in a glass manufacturing apparatus comprising a slot draw apparatus, a float bath apparatus, a down-draw apparatus (e.g., a fusion down draw apparatus), an up-draw apparatus, a pressing apparatus, a rolling apparatus, a tube drawing apparatus or any other glass manufacturing apparatus that would benefit from the present disclosure. By way of example, FIG. 1 schematically illustrates glass melting furnace 12 as a component of a fusion down-draw style glass manufacturing apparatus 10 for fusion drawing a glass ribbon for subsequent processing into individual glass sheets or rolling the glass ribbon onto a spool.

Glass manufacturing apparatus 10 can optionally include an upstream glass manufacturing apparatus 16 positioned upstream of melting vessel 14. In some examples, a portion of, or the entire upstream glass manufacturing apparatus 16, can be incorporated as part of the glass melting furnace 12.

As shown in the embodiment illustrated in FIG. 1, upstream glass manufacturing apparatus 16 can include a raw material storage bin 18, a raw material delivery device 20 and a motor 22 connected to raw material delivery device 20. Raw material storage bin 18 can be configured to store a quantity of raw material 24 that can be fed into melting vessel 14 of glass melting furnace 12 through one or more feed ports, as indicated by arrow 26. Raw material 24 typically comprises one or more glass forming metal oxides and one or more modifying agents. In some examples, raw material delivery device 20 can be powered by motor 22 to deliver a predetermined amount of raw material 24 from raw material storage bin 18 to melting vessel 14. In further examples, motor 22 can power raw material delivery device 20 to introduce raw material 24 at a controlled rate based on a level of molten glass sensed downstream from melting vessel 14 relative to a flow direction of the molten glass. Raw material 24 within melting vessel 14 can thereafter be heated to form molten glass 28. Typically, in an initial melting step, raw material is added to the melting vessel as particulate, for example as various “sands”. Raw material 24 can also include scrap glass (i.e., cullet) from previous melting and/or forming operations. Combustion burners are typically used to begin the melting process. In an electrically boosted melting process, once the electrical resistance of the raw material is sufficiently reduced, electric boost can begin by developing an electrical potential between electrodes positioned in contact with the raw material, thereby establishing an electrical current through the raw material, the raw material typically entering, or in, a molten state.

Glass manufacturing apparatus 10 can also optionally include a downstream glass manufacturing apparatus 30 positioned downstream of glass melting furnace 12 relative to a flow direction of molten glass 28. In some examples, a portion of downstream glass manufacturing apparatus 30 may be incorporated as part of glass melting furnace 12. However, in some instances, first connecting conduit 32 discussed below, or other portions of the downstream glass manufacturing apparatus 30, can be incorporated as part of the glass melting furnace 12.

Downstream glass manufacturing apparatus 30 may include a first conditioning (i.e., processing) chamber, such as fining vessel 34, located downstream from melting vessel 14 and coupled to melting vessel 14 by way of the above-referenced first connecting conduit 32. Molten glass 28 may be gravity fed from melting vessel 14 to fining vessel 34 by way of an interior pathway of first connecting conduit 32. Accordingly, first connecting conduit 32 provides a flow path for molten glass 28 from melting vessel 14 to fining vessel 34. However, other conditioning chambers may be positioned downstream of melting vessel 14, for example between melting vessel 14 and fining vessel 34. In some embodiments, a conditioning chamber can be employed between the melting vessel and the fining chamber. For example, molten glass from a primary melting vessel can be further heated in a secondary melting (conditioning) vessel or cooled in the secondary melting vessel to a temperature lower than the temperature of the molten glass in the primary melting vessel before entering the fining chamber.

As described previously, bubbles may be removed from molten glass 28 by various techniques. For example, raw material 24 may include multivalent compounds (i.e., fining agents) such as tin oxide that, when heated, undergo a chemical reduction reaction and release oxygen. Other suitable fining agents include without limitation arsenic, antimony, iron and cerium, although the use of arsenic and antimony may be discouraged for environmental reasons in some applications. Fining vessel 34 is heated, for example to a temperature greater than the melting vessel temperature, thereby heating the fining agent. Oxygen produced by the temperature-induced chemical reduction of one or more fining agents included in the molten glass diffuse into bubbles produced during the melting process. The enlarged gas bubbles with increased buoyancy can then rise to a free surface of the molten glass within the fining vessel and thereafter be vented out of the fining vessel.

The downstream glass manufacturing apparatus 30 may further include another conditioning chamber, such as mixing apparatus 36, for example a stirring vessel, for mixing the molten glass that flows downstream from fining vessel 34. Mixing apparatus 36 can be used to provide a homogenous glass melt composition, thereby reducing chemical or thermal inhomogeneities that may otherwise exist within the molten glass exiting the fining chamber. As shown, fining vessel 34 may be coupled to mixing apparatus 36 by way of a second connecting conduit 38. In some embodiments, molten glass 28 can be gravity fed from the fining vessel 34 to mixing apparatus 36 by way of an interior pathway of second connecting conduit 38. The molten glass within mixing apparatus 36 may include a free surface, with a free volume extending between the free surface and a top of the mixing apparatus. While mixing apparatus 36 is shown downstream of fining vessel 34 relative to a flow direction of the molten glass, mixing apparatus 36 may be positioned upstream from fining vessel 34 in other embodiments. In some embodiments, downstream glass manufacturing apparatus 30 may include multiple mixing apparatus, for example a mixing apparatus upstream from fining vessel 34 and a mixing apparatus downstream from fining vessel 34. These multiple mixing apparatus may be of the same design, or they may be of a different design from one another. One or more of the vessels and/or conduits may include static mixing vanes positioned therein to promote mixing and subsequent homogenization of the molten material.

Downstream glass manufacturing apparatus 30 may further include another conditioning chamber such as delivery vessel 40 located downstream from mixing apparatus 36. Delivery vessel 40 can condition molten glass 28 to be fed into a downstream forming device. For instance, delivery vessel 40 can act as an accumulator and/or flow controller to adjust and provide a consistent flow of molten glass 28 to forming body 42 by way of exit conduit 44. The molten glass within delivery vessel 40 can, in some embodiments, include a free surface, wherein a free volume extends upward from the free surface to a top of the delivery chamber. As shown, mixing apparatus 36 may be coupled to delivery vessel 40 by way of third connecting conduit 46. In some examples, molten glass 28 may be gravity fed from mixing apparatus 36 to delivery vessel 40 by way of an interior pathway of third connecting conduit 46.

Downstream glass manufacturing apparatus 30 may further include forming apparatus 48 comprising the above-referenced forming body 42, including inlet conduit 50. Exit conduit 44 can be positioned to deliver molten glass 28 from delivery vessel 40 to inlet conduit 50 of forming apparatus 48.

Components of downstream glass manufacturing apparatus 30, including any one or more of connecting conduits 32, 38, 46, fining vessel 34, mixing apparatus 36, delivery vessel 40, exit conduit 44, or inlet conduit 50 may be formed from a precious metal. Suitable precious metals include platinum group metals selected from the group consisting of platinum, iridium, rhodium, osmium, ruthenium and palladium, or alloys thereof. For example, downstream components of the glass manufacturing apparatus may be formed from a platinum-rhodium alloy including from about 70% to about 90% by weight platinum and about 10% to about 30% by weight rhodium. However, other suitable metals for forming downstream components of the glass manufacturing apparatus can include molybdenum, rhenium, tantalum, titanium, tungsten, and alloys thereof.

Forming body 42 in a fusion down-draw glass manufacturing apparatus can comprise a trough 52 positioned in an upper surface of the forming body, and converging forming surfaces 54 (only one surface shown) that converge in a draw direction along a bottom edge (root) 56 of the forming body. Molten glass delivered to forming body trough 52 via delivery vessel 40, exit conduit 44 and inlet conduit 50 overflows the walls of trough 52 and descends along converging forming surfaces 54 as separate flows of molten glass. The separate flows of molten glass join below and along root 56 to produce a single ribbon 58 of molten glass that is drawn along a draw plane in a draw direction 60 from root 56 by applying a downward tension to the glass ribbon, such as by gravity and/or pulling roll assemblies (not shown), to control dimensions of the glass ribbon as the molten glass cools and a viscosity of the material increases. Accordingly, glass ribbon 58 goes through a visco-elastic transition to an elastic state and acquires mechanical properties that give glass ribbon 58 stable dimensional characteristics. Glass ribbon 58 comprises first outer edges 62a and second outer edge 62b opposite first outer edge 62a, the first and second outer edges extending lengthwise along glass ribbon 58. Glass ribbon 58 may further comprise first thickened edge portion 64a and second thickened edge portion 64b (hereinafter first bead 64a and second bead 64b, respectively), beads 64a, 64b extending inward from respective first and second outer edges 62a, 62b. Glass ribbon 58 comprises a width W defined between first and second outer edges 62a and 62b. First and second beads 64a, 64b can comprise a thickness greater than a thickness of the glass ribbon along a longitudinal centerline of the glass ribbon. The glass ribbon extending between first bead 64a and second bead 64b can be referred to as the “quality” region 66 of the glass ribbon. Quality region 66 exhibits a substantially uniform thickness and pristine or substantially pristine surfaces and is the most commercially valuable portion of the ribbon, as the beads are typically removed and used as cullet or scrapped. Glass ribbon 58 may, in some embodiments, be separated into individual glass sheets 68 by a glass separation apparatus 100, although in further embodiments, the glass ribbon 58 may be wound onto spools and stored for further processing.

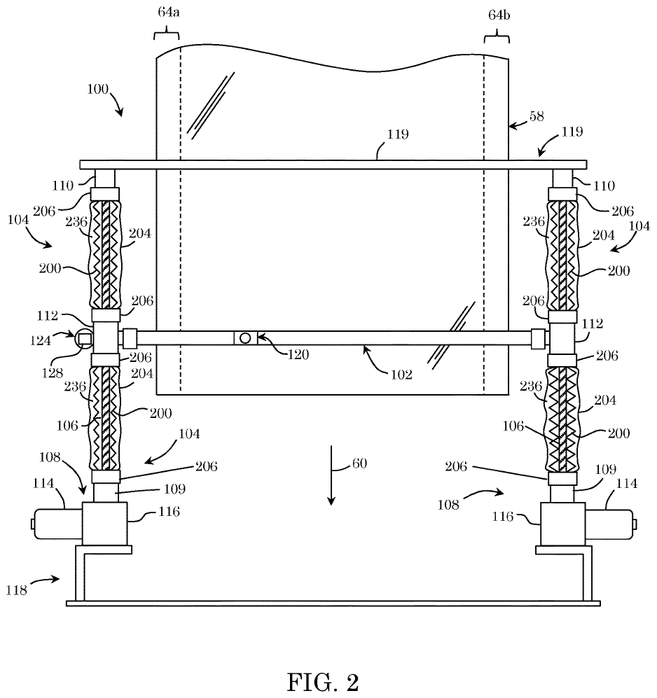

As shown in FIG. 2 glass separation apparatus 100 can comprise a carriage assembly 102 supported by a plurality of drive assemblies 104. Each drive assembly 104 of the plurality of drive assemblies comprises a screw shaft 106 coupled to a drive unit 108 and optionally a first bearing assembly 109 at one end of the screw shaft and a second bearing assembly 110 at an opposing end of the screw shaft. In addition, a nut assembly 112 can be coupled to each screw shaft 106, and each nut assembly 112 can be coupled to carriage assembly 102, for example at opposite ends of the carriage assembly. Glass separation apparatus 100 may comprise at least two drive assemblies 104, one drive assembly positioned at and coupled to a first end of carriage assembly 102 via a first nut assembly 112 and a second drive assembly positioned at and coupled to a second end of carriage assembly 102 via a second nut assembly 112. In some embodiments, glass separation apparatus 100 may comprise at least four drive assemblies 104, two drive assemblies at one end of carriage assembly 102 and two drive assemblies positioned at and coupled to the opposite end of carriage assembly 102.

Carriage assembly 102 may further comprise a scoring unit 120 for scoring glass ribbon 58 and a scoring unit drive assembly 124 for traversing scoring unit 120 along carriage assembly 102. Scoring unit drive assembly 124 may comprise, for example, a belt configured as an endless loop coupled to a drive motor 128 and supported by a rail member and rollers, wherein scoring unit 120 is also coupled to the belt. However, other methods of driving scoring unit 120 may be employed. For example, scoring unit 120 may be coupled to a linear actuator that moves the scoring unit along a length of the carriage. Scoring unit 120 can be traversed along carriage assembly 102 to draw direction 60 across glass ribbon 58 by scoring unit drive assembly 124 to score glass ribbon 58.

Each drive unit 108 associated with carriage assembly 102 can comprise a drive motor 114 and a reduction gear assembly 116 that couples drive motor 114 to screw shaft 106. Each drive motor 114 may be a dedicated drive motor. That is, the drive motor may be dedicated to a single screw shaft 106 (drives a single screw shaft 106 and does not drive other screw shafts). Accordingly, if there are, for example, two drive units 108, there are two drive motors 114 coupled to two screw shafts 106 by two reduction gear assemblies 116. If there are four drive units 108, there are four drive motors 114 coupled to four screw shafts 106 by four reduction gear assemblies 116. A reduction ratio of the reduction gear assemblies 116 can be less than 5:1, for example, in a range from about 4:1 to about 2:1, such as about 3.5:1. A reduction ratio less than 5:1 provided by reduction gear assemblies 116 and/or dedicated drive motors 114 can reduce the load borne by each drive assembly 104 during operation of the drive assemblies. Thus, in such embodiments, smaller motors may be used than would otherwise be needed if, for example, only a single drive motor was used for a pair of drive assemblies. Additionally, component lifetimes may be improved, and vertical traverse speed of carriage assembly 102 may be increased, especially during an upward traverse, thereby improving cycle time.

Drive units 108 can be supported by lower frame portion 118. Lower frame portion 118 may be any suitable rigid support capable of supporting the weight of glass separation apparatus 100. For example, lower frame portion 118 may be attached to building girders, concrete flooring, or other suitable structural members of the building. In embodiments, lower frame portion 118 can be a stand-alone structure. Glass separation apparatus 100 may further comprise an upper frame portion 119 coupled to drive assemblies 104 at the upper ends of drive assemblies 104, for example at support bearings 110 mounted to upper frame portion 119. Upper frame portion 119 can provide rigidity to drive assemblies 104 and ensure uniform and consistent spacing between the drive assemblies (e.g., threaded shafts 106). Upper drive portion 119 may be connected with lower frame portion 118.

Each nut assembly 112 can comprise a plurality of ball bearings housed in a housing and the plurality of ball bearings engage with raceways of screw shaft 106. To wit, each drive assembly 104 may comprise a ball screw apparatus wherein each screw shaft 106 is rotatable by a respective drive unit 108. As the screw shaft is rotated by the respective drive unit 108, the nut assembly 112 travels along a length of the screw shaft according to the direction of rotation of screw shaft 106. Ball screw apparatus are known in the art, and their construction will not be described further. Because carriage assembly 102 is supported on screw shafts 106 by nut assemblies 112, rotation of screw shafts 106 by their respective drive units 108 either raises or lowers carriage assembly 102 depending on the direction of rotation of the screw shafts.

Drive units 108 are used to traverse carriage assembly 102 during a scoring operation. As glass ribbon 58 is drawn downward in draw direction 60 at a draw speed, carriage assembly 102 is traversed downward parallel to draw direction 60 at a downward traverse speed equal to the draw speed. During this downward traverse, the scoring unit 120 is traversed across the width of the glass ribbon, whereupon a scoring tool arranged in the scoring unit scores the glass ribbon across at least a portion of the glass ribbon width. A robot (not shown) downstream of carriage assembly 102 bends the glass ribbon at the score, thereby separating a glass sheet from the glass ribbon. Upon completion of the scoring and separating operations, the drive units 108 reverse the rotation of screw shafts 106 and traverse carriage assembly 102 upward to a holding location until a sufficient length of glass ribbon has past the holding location for another glass sheet to be separated, whereupon the drive units once again traverse the carriage assembly downward at the draw speed, while the scoring unit scores the glass ribbon. Synchronization of the downward traverse speed of carriage assembly 102, and thereby scoring unit 120, with the draw speed allows a score to be made in glass ribbon 58 that is orthogonal to the edges of the glass ribbon while the glass ribbon is moving.

Operation of the separation apparatus relies on adequate lubrication of drive units 108, and in particular screw shafts 106. Additionally, the separation of glass sheets from glass ribbon 58 produces glass particles, which can adhere to portions of the drive units, such as the screw shafts, which can be exacerbated by the lubricant. Thus, a bellows 200 may be provided around the screw shaft. A bellows 200 may be coupled to both portion of the screw shaft, one positioned around the lower portion of the screw shaft below nut assembly 112, and one positioned around the upper portion of the screw shaft above nut assembly 112. For example, the lower bellows 200 may be coupled to carriage assembly 102 at one end and to drive unit 108 at the opposite end. A second bellows 200 may be positioned around screw shaft 106 between carriage assembly 102 and upper frame portion 119, for example second, upper bearing assembly 110. The accordion-like pleated form of bellows 200 allows the lower bellows 200 to compress and the upper bellows 200 to expand during downward traverse of carriage assembly 102, and conversely, for upper bellows 200 to compress and lower bellows 200 to expand during upward traverse of carriage assembly 102.

Bellows 200 may be insufficient to prevent staining of the glass ribbon, and glass sheets separated therefrom, by lubricant from drive units 108. For example, because the area around the separating apparatus may be heated to control cooling of the glass ribbon, and thereby stress in the glass ribbon, the lubricant can be vaporized. Moreover, rather than a unitary bellows, for example molded rubber bellows, in some embodiments bellows 200 may be formed from individual pieces joined together, for example taped together. In some embodiments, bellows 200 may be formed from a laminated material. In some embodiments, the laminated material may comprise an aluminum layer, a polymer layer such as polyvinyl chloride (PVC), and an organic paper layer such as Kraft paper. The laminated material may include glass fiber. For example, the laminated material may comprise an aluminum-glass fiber outer layer, a Kraft paper intermediate layer, and a PVC inner layer, and can be obtained from Alpha Associates, Lakewood, NJ, USA, as Alpha-Shield). Vaporized lubricant may penetrate through seams between individual pieces of the bellows and deposit, e.g., condense, on glass ribbon 58. Lubricant contamination of the glass ribbon may be difficult to remove and may permanently stain the glass ribbon.

To provide a further barrier to lubricant escaping from bellows 200, a secondary shield in the form of a bellows cover 204 may be disposed about each bellows 200. Bellows cover 204 may be a fabric (e.g., a woven, knitted, or felted fabric) configured in a tube shape, wherein the bellows 200, and screw shaft 106 positioned therein, may be arranged within the interior of the tube. The bellows cover fabric may comprise silica. For example, in embodiments, the fabric may comprise glass fiber (e.g., a fiberglass fabric). In embodiments, the fabric may comprise Heptasil™ 610, available from Heptagon Industries, Singapore. Bellows cover 204 may be formed into a tube, for example, by joining opposing edges of the fabric along a seam 205, e.g., by taping, or affixed by other means, such as by hook-and-loop fastening (e.g., Velcro®), to form the tube, the tube extending around the bellows 200. The use of hook-and-loop fastening facilitates quick installation or removal of the bellows cover during operation of the glass manufacturing apparatus, for example for replacement or cleaning. Bellows cover 204 is heat resistant and flexible, allowing the bellows cover to compress and expand in unison with bellows 200 as the bellows alternately compresses and expands during the reciprocating traverse of carriage assembly 102. Additionally, bellows cover 204 may reduce the temperature of the environment within the bellows, thereby reducing vaporization of lubricant from the crew shaft and subsequent contamination of the glass ribbon. Bellows covers 204 have been found to reduce the temperature within the bellows (e.g., between the bellows 200 and the screw shaft 106) by as much as 20%.

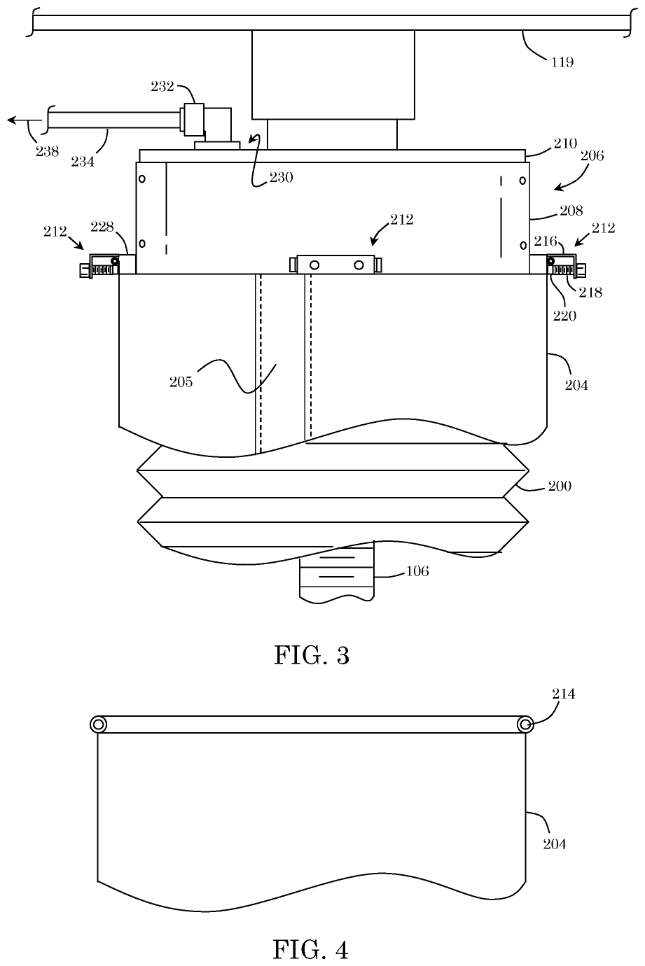

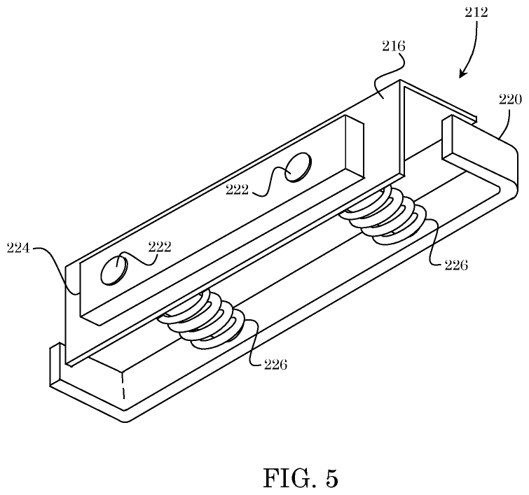

One end of bellows cover 204 may be coupled to a corresponding frame portion e.g., upper frame portion 119 or lower frame portion 118, for example to bearing assemblies 109, 110, or another supporting unit, by clamping apparatus 206. In FIG. 3, a bellows cover 204 is shown disposed around an upper portion of screw shaft 106 and bellows 200 and coupled to upper frame portion 119 between carriage assembly 102 and the upper frame portion. Similarly, the opposing end of bellows cover 204 may be coupled to carriage assembly 102, for example by a second clamping apparatus 102. Clamping apparatus 206 may include a shroud 208 and a plate 210. One or more restraining clamps 212 attached to shroud 208 may engage with a shaped wire 214 disposed at one or both ends of bellows cover 204. That is, bellows cover 204 may include a shaped wire 214 attached to the bellows cover at an end of the bellows cover to maintain a shape of the bellows cover at the end thereof and provide a rigid member on which to clamp the bellows cover. For example, the shaped wire may be inserted into a loop formed in an end of the bellows cover. In the embodiment shown in FIG. 3, the restraining clamps 212 engage the bellows cover 204 such that the shaped wire is captured by the restraining clamp, thereby preventing removal of the bellows cover until the clamp is loosened or removed. As shown in FIG. 4, shaped wire 214 may, for example, be inserted into a loop at the end of the bellows cover. In the embodiment shown in FIG. 3, each restraining clamp 212 may include a bracket 216 attached to shroud 208, one or more clamping screws 218, and a clamping bar 220. As shown, bracket 216 may be an L-shaped bracket, wherein the one or more clamping screws 218 engage with the bracket via threaded apertures in the bracket, clamping screws 218 further engaging with the clamping bar. However, referring to FIG. 5, in further embodiments, clamping screws 218 may be replaced with a pin 222 extending through an aperture in bracket 216 and slidably engaged therewith, the pin 222 attached to clamping bar 220 at a distal end of the pin. The opposing, proximal end of the pin is attached to stop member 224. Accordingly, clamping bar 220 and stop member 224 are movable relative to bracket 216 along a longitudinal axis of pin 222 as pin 222 slides within the aperture in bracket 216. Additionally, pin 222 extends through a spring 226, e.g., a helical compression spring, wherein spring 226 is captured on pin 222 between bracket 216 and clamping bar 220. Spring 226 applies a biasing spring force against clamping bar 220 such that when bellows cover 204 is positioned between clamping bar 220 and shroud 208, e.g., a clamping block 228 coupled to or part of shroud 208, the biasing spring force presses clamping bar 220 against the bellows cover (e.g., clamping block) and holds the bellows cover in place against shroud 208. Shaped wire 214 prevents the bellows cover from being pulled from the restraining clamp until spring 226 is compressed, releasing the biasing spring force from the bellows cover and allowing bellows cover 204 to be removed. In embodiments, restraining clamp 212 may comprise a plurality of pins and springs. For example, in the embodiment shown in FIG. 5, restraining clamp 212 comprises two sets of pins 222 and springs 226. Shroud 208 may be coupled to plate 210, wherein plate 210 may in turn be coupled to the corresponding frame portion, e.g., bearing assembly 109, 110, or other mounting structure coupled to the corresponding frame portion.

In embodiments, plate 210 may include an exhaust port 230 comprising a fitting 232 installed therein configured to receive a tubing line 234 in fluid communication with a vacuum source (not shown). The exhaust port 230 provides fluid communication between tubing line 234 and interior space 236 between bellows cover 204 and bellows 200 such that air within interior space 236 may be exhausted, along with particles therein, as indicated by arrow 238. For example, bellows cover 204 itself may shed small fiber particles. As carriage assembly 102 traverses the screw shaft in a direction that compresses bellows 200 (and bellows cover 204), particles shed by the bellows cover may be exhausted from interior space 236 between the bellows cover and the bellows. Such exhausted particles may then contaminate glass ribbon 58. Removing particles from interior space 236 via vacuum reduces the opportunity for exhaustion of such particles into the open atmosphere of the manufacturing facility.

In embodiments, both ends of bellows cover 204 may be coupled to the respective upper or lower frame portion by a clamping apparatus 206, and each clamping apparatus 206 may be placed in fluid communication with the vacuum source by a tubing line 234 such that particles within interior space 236 between bellows cover 204 and bellows 200 may be evacuated from interior space 236. The applied vacuum may also be effective to remove lubricant vapors from interior space 236.

Clamping apparatus 206 may couple bellows 200 and bellows cover 204 to a respective frame portion (e.g., lower frame portion 118 or upper frame portion 119), and/or to carriage assembly 102. For example, each set of a bellows 200 and a bellows cover 204 extending between a respective frame portion (e.g., lower frame portion 118 or upper frame portion 119) and carriage assembly 102 and surrounding a portion of screw shaft 106 may be coupled to the respective frame portion and carriage assembly 102 by a clamping apparatus 206 so that a vacuum may be applied to the interior space between bellows 200 and bellows cover 204, and the interior space between bellows 200 and screw shaft 106 at both ends of bellows 200 and bellows cover 204. Thus, for example, each screw shaft 106 may have two sets of bellows 200 and bellows cover 204, a first set of bellows 200 and bellows cover 204 positioned between one end of carriage assembly 102 and a frame portion (e.g., lower frame portion 118 or upper frame portion 119), and a second set of bellows 200 and bellows cover 204 positioned between the one end of the carriage assembly 102 and the other of the upper or lower frame portion. A second screw shaft coupled to the opposite end of the carriage assembly may comprise similar sets of bellows and bellows covers. In some embodiments, glass separation apparatus 100 may comprise multiple screw shafts and associated nut assemblies positioned at each end of carriage assembly 102. For example, the glass separation apparatus may comprise two screw shafts coupled to a first end of carriage assembly 102 and two screw shafts coupled to a second end of carriage assembly 102. Each screw shaft may be protected above and below the carriage assembly by a bellows. That is, an upper portion of each screw shaft above the carriage assembly may comprise a bellows, and each screw shaft below the carriage assembly may comprises a bellows. In some instances, the bellows cover associated with the upper bellows may be sized to accommodate both upper bellows within a single upper bellows cover. Similarly, the bellows cover associated with the lower bellows may be sized to accommodate both lower bellows with a single lower bellows cover.

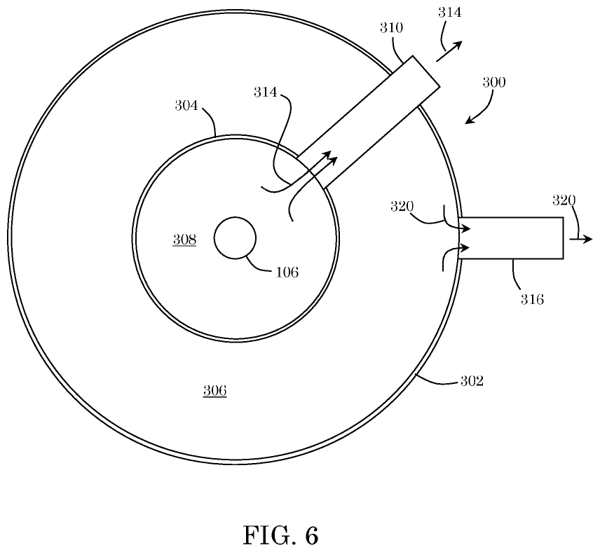

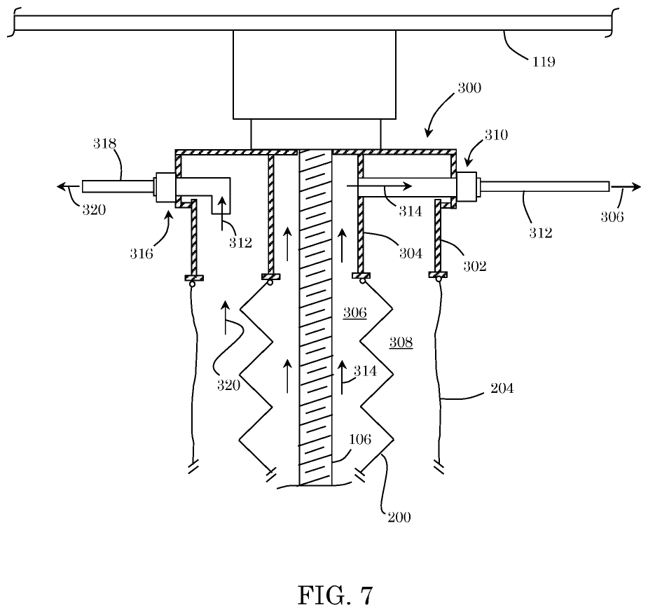

Turning to FIGS. 6 and 7, in some embodiments, bellows cover 204 may be coupled to a vacuum ring 300 disposed between bellows cover 204 and the respective upper or lower frame portion. Vacuum ring 300 may include multiple exhaust ports in fluid communication with tubing lines in fluid communication with one or more vacuum sources. In embodiments, the vacuum ring may include a first, outer ring wall 302, a second, inner ring wall 304 positioned inside outer ring wall 302, such as concentric with outer ring wall 302. Inner ring wall 304 is spaced apart from outer ring wall 302 by a first gap 306 and spaced apart from screw shaft 106 by a second gap 308. Bellows 200 may be coupled to inner ring wall 304 and bellows cover 204 may be coupled to outer ring wall 302, whereby first gap 306 between bellows 200 and screw shaft 106 is isolated from second gap 308 between bellows 200 and bellows cover 204. Vacuum ring 300 may include at least one first exhaust port 310, and associated tubing line 312 in fluid communication with a first vacuum source (not shown), configured to exhaust lubricant vapors from the space between screw shaft 106 and bellows 200, as indicated by arrows 314, and at least one second exhaust port 316, and associated tubing line 318 in fluid communication with the first vacuum source, or a second vacuum source, configured to remove particles between bellows 200 and bellows cover 204, as indicated by arrows 320. Vacuum ring 300 may couple bellows 200 and bellows cover 204 to a respective frame portion (e.g., lower frame portion 118 or upper frame portion 119), and/or to carriage assembly 102. For example, each set of a bellows 200 and a bellows cover 204 extending between a respective frame portion (e.g., lower frame portion 118 or upper frame portion 119) and carriage assembly 102 and surrounding a portion of screw shaft 106 may be coupled to the respective frame portion and carriage assembly 102 by a vacuum ring 300 so that a vacuum may be applied to the first gap 306 and the second gap 308 at both ends of the gap (i.e., both ends of bellows 200 and bellows cover 204).

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

1. A glass manufacturing apparatus, comprising:
a forming body configured to form a glass ribbon;
a separation apparatus configured to separate the glass ribbon, the separation apparatus comprising:
a frame assembly comprising an upper frame portion and a lower frame portion;
a carriage assembly;
a drive assembly comprising a screw shaft coupled to the carriage assembly and extending between the upper frame portion and the lower frame portion;
a bellows extending over the screw shaft; and
a bellows cover extending over the bellows.

2. The glass manufacturing apparatus of claim 1, wherein the bellows comprises aluminum.

3. The glass manufacturing apparatus of claim 1, wherein the bellows comprises a polymer.

4. The glass manufacturing apparatus of claim 1, wherein the bellows cover comprises a fabric.

5. The glass manufacturing apparatus of claim 4, wherein the fabric comprises glass fiber.

6. The glass manufacturing apparatus of claim 1, further comprising a first clamp assembly coupling a first end of the bellows cover to the carriage assembly, the first clamp assembly comprising a first vacuum line extending between a vacuum source and the first clamp assembly such that the vacuum source is in fluid communication with an interior space between the bellows and the bellows cover.

7. The glass manufacturing apparatus of claim 6, further comprising a second clamp assembly coupling a second end of the bellows cover to the lower frame portion, the second clamp assembly comprising a second vacuum line extending between the vacuum source and the second clamp assembly such that the vacuum source is in fluid communication with the interior space between the bellows and the bellows cover.

8. The glass manufacturing apparatus of claim 1, wherein the glass manufacturing apparatus comprises a vacuum ring comprising a first ring wall, a second ring wall inside of and spaced apart from the first ring wall by a first gap and spaced apart from the screw shaft by a second gap, the bellows cover coupled to the first ring wall and the bellows coupled to the second ring wall, a first vacuum line coupled to the vacuum ring and in fluid communication with the first gap, and a second vacuum line coupled to the vacuum ring and in fluid communication with the second gap, and wherein the first gap is not in fluid communication with the second gap.

9. The glass manufacturing apparatus of claim 8, further comprising a second vacuum ring coupling a second end of the bellows cover to the lower frame portion.

10. The glass manufacturing apparatus of claim 1, wherein the drive assembly comprises a ball screw.

11. A glass manufacturing apparatus, comprising:
a forming body configured to form a glass ribbon;
a separation apparatus configured to separate the glass ribbon, the separation apparatus comprising:
a frame assembly comprising an upper frame portion and a lower frame portion;
a carriage assembly;
a drive assembly comprising a screw shaft extending between the upper frame portion and the lower frame portion, the screw shaft coupled to a drive motor configured to turn the screw shaft, and a nut assembly coupled to the carriage assembly and engaged with the screw shaft such that rotation of the screw shaft by the drive motor moves the carriage assembly along the screw shaft between the upper frame portion and the lower frame portion;
a bellows extending over the screw shaft between the lower frame portion and the carriage assembly; and
a bellows cover extending over the bellows.

12. The glass manufacturing apparatus of claim 11, wherein the bellows cover comprises a fiberglass fabric.

13. The glass manufacturing apparatus of claim 11, further comprising a first clamp assembly coupling a first end of the bellows cover to the carriage assembly, the first clamp assembly comprising a first vacuum line extending between a vacuum source and the first clamp assembly such that the vacuum source is in fluid communication with an interior space between the bellows and the bellows cover.

14. The glass manufacturing apparatus of claim 13, further comprising a second clamp assembly coupling a second end of the bellows cover to the lower frame portion, the second clamp assembly comprising a second vacuum line extending between the vacuum source and the second clamp assembly such that the vacuum source is in fluid communication with the interior space between the bellows and the bellows cover.

15. The glass manufacturing apparatus of claim 11, wherein the glass manufacturing apparatus comprises a vacuum ring comprising a first ring wall, a second ring wall inside of and spaced apart from the first ring wall by a first gap and spaced apart from the screw shaft by a second gap, the bellows cover coupled to the first ring wall and the bellows coupled to the second ring wall, a first vacuum line coupled to the vacuum ring and in fluid communication with the first gap, and a second vacuum line coupled to the vacuum ring and in fluid communication with the second gap, and wherein the first gap is not in fluid communication with the second gap.
